(19) United States
(12) Patent Application Publication
(10) Pub. No.: US 2015/0323093 A1
(43) Pub. Date: Nov. 12, 2015

(54) VALVE ARRANGEMENT FOR VENTING GAS FROM LIQUID CIRCULATING IN A SUBSEA PRODUCTION SYSTEM

(71) Applicant: VETCO GRAY SCANDINAVIA. AS, Billingstad (NO)

(72) Inventor: Anne Margrethe MOSLAND, Billingstad (NO)

(21) Appl. No.: 14/652,857

(22) PCT Filed: Dec. 11, 2013
(86) PCT No.: PCT/IB2013/002741

§ 371 Date: Jun. 17, 2015

(30) Foreign Application Priority Data
Dec. 21, 2012 (NO) 20121555

(51) Int. Cl. F16K 31/20; F16K 1/32; F16K 17/04

(52) U.S. Cl. CPC F16K 31/20; F16K 17/04; F16K 1/32

(57) ABSTRACT

A gas venting valve arrangement is disclosed, the gas venting valve arrangement comprising a valve housing having an inlet in a bottom region of the housing connectable to a fluid flow to be passing through a subsea pump or compressor, and an outlet for gas accumulating in a top region of the housing. A valve mechanism operating a movable valve body at the outlet' between open and closed positions. A floater in the housing actuating the, valve mechanism, wherein the floater is acted upon by a force means which is dimensioned to increase buoyancy of the floater with respect to a liquid phase of the fluid accumulating in a bottom region of the housing.

### TECHNICAL FIELD OF THE INVENTION

The present invention relates to a valve arrangement configured for collecting and periodically venting fractions of gas that is entrained in liquid circulating through a subsea production system, such as through a pump or compressor used in subsea hydrocarbon production.

### BACKGROUND AND PRIOR ART

In the recovery of oil and/or gas from subsea hydrocarbon wells, pumps and compressors are conventionally used to aid in transportation of the fluid to a platform at sea or land.

The motors, seals and bearings in subsea pumps or compressors need protection from intrusion of foreign material that could hamper the operation of the pump or compressor. To this purpose, liquid such as oil can be circulated through the subsea pump or compressor to create a pressure barrier which prevents intrusion of pumped fluid or seawater into the motors, seals and bearings. Oil, or seawater, may additionally be circulated through the subsea pump or compressor for cooling purposes. In all cases, accumulation of gas in a barrier liquid circuit is disadvantageous and undesired and may occasionally cause failure in production.

Venting of accumulated gas is conventionally accomplished by means of a gas release valve connected to the subject liquid circuit. A floater unit in the valve may be arranged to shift the valve between open and closed positions via a relatively simple mechanical valve opening and closing system. However, at larger water depths and corresponding pressures in the order of hundreds of bars, the structural demands on the floater leads to an increase of the floater's mass, ultimately to a point where the mass is greater than the resulting buoyancy, rendering the conventional floater solution non-usable in deep water applications. Other prior solutions involve electronic gas detection systems with electrically actuated gas release valves, which require control and power. However, the more complex a system, the greater need for monitoring and control and the greater is the risk of faults and malfunction, such as electronic malfunction, leaks and structural faults, e.g.

### SUMMARY OF THE INVENTION

The present invention aims at providing a gas venting valve arrangement of pure mechanical structure for operation in a subsea environment.

Another object is to provide a gas venting valve arrangement that provides a fail-safe function.

The objects are met in a gas venting valve arrangement as disclosed below.

Briefly, the gas venting valve arrangement comprises a valve housing having an inlet in a bottom region of the housing connectable to a liquid circuit in a subsea production system, and an outlet for gas accumulating in a top region of the housing. A valve mechanism in the housing operates a movable valve body at the gas outlet between open and closed positions. A floater in the housing actuates the valve mechanism. The floater is acted upon by a force means which is dimensioned to increase buoyancy of the floater with respect to a liquid phase of the fluid, accumulating in a bottom region of the housing.

In an embodiment, the force means is a tension spring supporting the floater from a ceiling of the housing. In an alternative embodiment, the force means is a compression spring supporting the floater from a floor to the housing.

The force means thus acts as a mass adjuster, rendering buoyancy to a floater body which is structured to withstand the gas and fluid pressures associated with deep water applications such as in subsea hydrocarbon production. In combination, the floater mass and spring force neutralizes the floater with respect to the system pressure, i.e. the specific density of the gas and the specific density of the fluid.

In a structurally non-complex embodiment of the invention, the floater is mechanically linked to the valve body and the movement of the valve body is proportional to the movement of the floater.

In an embodiment, the linkage between the floater and the valve body includes a gear wheel in the valve mechanism which engages a gear rack on the floater.

In order to promote a jam-free motion, the housing comprises guide means configured to control the floater in a linear vertical movement, as well as guide means configured to control the valve body in a linear vertical movement.

A cam and cam follower arrangement is arranged in the valve mechanism to convert rotation of the gear wheel to a linear movement of the valve body. The cam and cam follower arrangement comprises a finger moving in a circular path with the gear wheel, the finger engaging a guide slot formed in a lower end of a valve rod, an upper end of which carries the valve body. The valve body may be realized as a valve cone formed in the upper end of the valve rod and fitting into a conical valve seat aligned with the valve rod.

In an embodiment the length of the gear rack on the floater and the radius of the gear wheel in the valve mechanism are mutually correlated in such way that almost a full circle of rotation of the gear wheel is generated during maximum travel of the floater. The embodiment ensures a built-in fail-safe functionality since the valve, which is normally closed, will be actuated through a full operating cycle from closed-to-open-to-closed, wherein the halfway movement being the nominal operating mode. Thus if the spring should fail, e.g., and the floater sinks towards the floor of the valve housing, the gear system ratio will ensure that the valve be fail-close.

To this purpose, in an embodiment, the gear wheel and gear rack are engaged with a ratio that defines the maximum length of travel of the valve body in the closed-to-open direction as less than 50% of the maximum travel of the floater towards the floor. In other words, during the full operating cycle from closure to closure, the finger in the cam and cam follower arrangement moves in a circular path from one side of an upper vertical center to the other side thereof. The finger is thus not allowed to pass the upper vertical center, and the floater is in the uppermost and lowermost end positions arrested by the valve in its closed position, due to a non-loose fit between the gear wheel and the gear rack.

In detail, an embodiment of the valve operating mechanism comprises a valve rod that is journalled to slide in a linear guide supported on an inside wall of the valve housing. The valve body is carried in an upper end of the valve rod, above the guide. A lower end of the valve rod below the guide is shaped as a fork having two legs, each of which carries a guide slot oriented transversely to the longitudinal direction of the valve rod. A couple of disks are arranged inwardly of said legs, each of the disks carrying a finger projecting into one of said guide slots, respectively. The disks are interconnected by an axle that is non-rotationally passing through the center of a gear wheel. The axle is journalled for rotation in a bracket projecting from the inside wall of the housing.

The floater may be realized as a hollow or a solid body dimensioned to withstand the pressures prevailing in a deep sea fluid circuitry, such as the pressures maintained in a barrier fluid circuit for a subsea pump or compressor. The floater may be a solid or hollow metal body, and has typically a volume/weight ratio that results in a specific gravity above 1. The floater body is arranged connectable to a tension spring. A groove, running in longitudinal direction, is formed on the exterior of the floater body. A gear rack running in longitudinal direction opposite to the groove is likewise supported or formed on the exterior of the floater body.

The valve housing is a hollow body or canister, the longitudinal walls, top and bottom of which are dimensioned to withstand the pressures prevailing at deep water applications. The valve housing is typically made of metal. The valve housing comprises a mounting bracket for the valve mechanism, the bracket projecting inwardly from an inside wall of the housing. A first guide vane is arranged to project inwardly from the inside wall of the housing, running in longitudinal direction opposite to the mounting bracket. A couple of second guide vanes are projecting inwardly from the inside wall of the housing, running in longitudinal direction and equally angularly spaced from the first guide vane. The at least three guide vanes ensure a jam-free linear movement of the floater that travels with changes in height of the liquid level in the valve housing.

Gas that accumulates in the top region of the valve housing effects a lowering of the liquid level and of the floater, whereby gas is automatically released via the opening valve until rising fluid level and the floater again closes the valve. The operation is thus not limited with respect to fluid composition and gas volume fraction in the fluid. Neither is the valve arrangement of the present invention limited to a specific subsea application. The valve arrangement may however be applied in a barrier fluid system, wherein the inlet to the valve housing is connected to a liquid circuit supplying barrier fluid to a subsea pump or compressor.

### DRAWINGS

The invention will be more closely explained below with reference to the drawings, schematically illustrating an embodiment of a gas venting valve arrangement according to the present invention. In the drawings:

FIG. 1 is a longitudinal section through a center of the valve arrangement showing the valve in closed state;

FIG. 2 shows the valve arrangement of FIG. 1 in a sectional plane II-II;

FIG. 3 is a longitudinal section corresponding to FIG. 1, showing the valve in fully open state;

FIG. 4 is a corresponding longitudinal section showing the valve arrangement in fail-close mode, and

FIG. 5 is an off-center longitudinal section (plane V-V in FIG. 2) illustrating a cam and cam follower arrangement in a valve operating mechanism of the subject valve arrangement.

### DETAILED DESCRIPTION

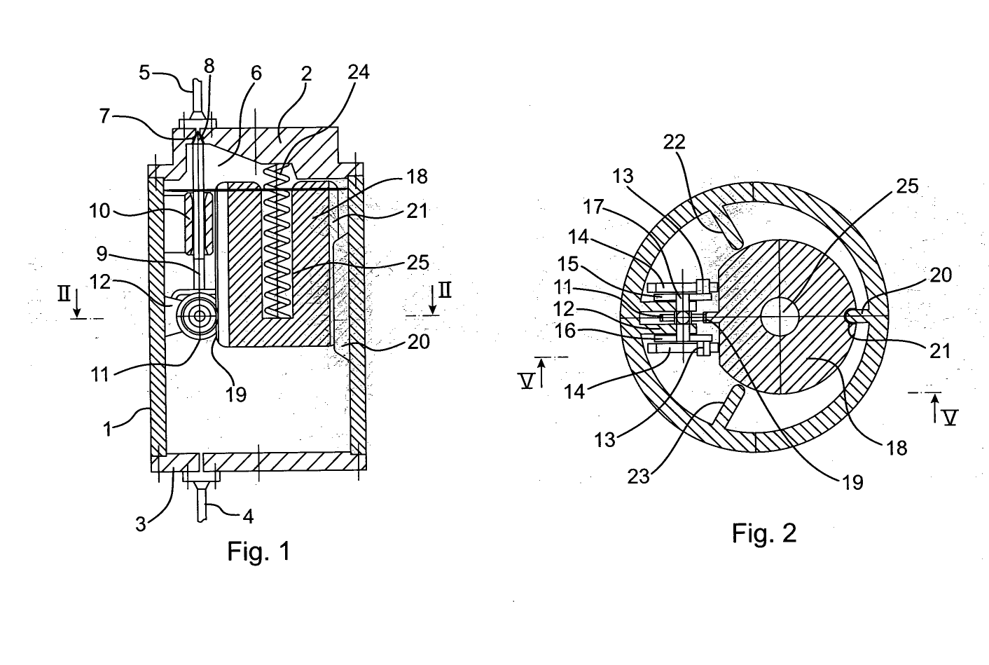

Reference is made to FIG. 1 disclosing a valve arrangement being housed in a valve housing 1 providing a pressure vessel. The valve housing 1 comprises a top cover 2 and a bottom 3 which are interconnected through a wall that encloses the components of the valve arrangement. In the bottom is arranged an inlet 4 for liquid. The inlet 4 is connectable to a liquid circuit, such as a barrier fluid circuit in a subsea pump or compressor installation, e.g. In the top cover is arranged an outlet 5 effective for venting out gas that accumulates below the top cover 2, in a top region 6 of the valve housing.

The outlet 5 is associated with a valve which effects opening of the outlet in result of an increasing gas volume in the top region of the valve housing, as will be explained below. The valve is realized through a valve seat 7 and a mating valve body 8. The valve seat and the valve body may be conical in shape and aligned with the outlet. The valve body is movable and actuated between open and closed states through a valve operating mechanism.

With reference also to FIGS. 2 and 5 the valve mechanism comprises a valve rod 9, in an upper end of which the valve body is supported. The valve rod 9 is journalled for linear movement back and forth in a rod guide 10. The rod guide is shaped as a sleeve and supported from the inside wall of the valve housing. The movement of the valve rod 9 is generated through a cam and cam follower arrangement driven by a gear wheel 11. The gear wheel is journalled in a bracket 12 that projects from the inside wall of the valve housing. A cam finger 13 is arranged to rotate with the gear wheel, the cam finger engaging a cam follower in the shape of a slot 14 that is arranged in a lower end of the valve rod 9, transversely oriented relative to the valve rod. More precisely, as shown in FIG. 2, two oppositely arranged cam fingers 13 project into a respective slot 14, each slot 14 arranged in one of a couple of legs forming a fork-shaped lower end of the valve rod 9. The cam fingers 13 are carried on a respective disk 15 and 16, the disks being interconnected by an axle 17 that is non-rotationally passing through the center of the gear wheel 11. The axle 17 is journalled for rotation in the bracket 12.

Accordingly, rotation of the gear wheel 11 is transformed via the cam and cam follower arrangement into a linear back and forth movement of the valve rod 9, thus opening or closing the valve and the gas venting passage via the outlet 5.

Actuation of the valve mechanism is accomplished by means of a floater 18 which is arranged in the valve housing to follow changes in the level of liquid that accumulates in the bottom region of the valve housing. In the drawings, the liquid level is represented by a bold horizontal line. More precisely, a gear rack 19 is arranged on the exterior of the floater and engages the gear wheel 11 to cause rotation of the gear wheel as the floater changes its position in the valve housing. In order to ensure a non-slip engagement between the gear rack 19 and the gear wheel 11 the floater is guided to move linearly, in parallel with the valve rod 9. To this purpose a guide vane 20 is arranged projecting from the inside wall of the valve housing to engage by insertion into a longitudinal recess 21 that is formed on the exterior of the floater 18, opposite to the gear rack 19. A couple of additional guide vanes 22 and 23 are likewise arranged projecting from the inside wall of the valve housing to engage the exterior of the floater 18, at angularly spaced locations, this way controlling the floater from three equally or substantially equally spaced positions about the floater. The guide vanes 20, 22 and 23 may all be shaped with rounded vertical edges, providing low-frictional line contacts between curved faces on the floater and on the vanes, respectively.

Since the valve housing 1 is typically installed in a vertical orientation it is reasonable to regard the movements of both the valve rod and the floater as guided vertical movements.

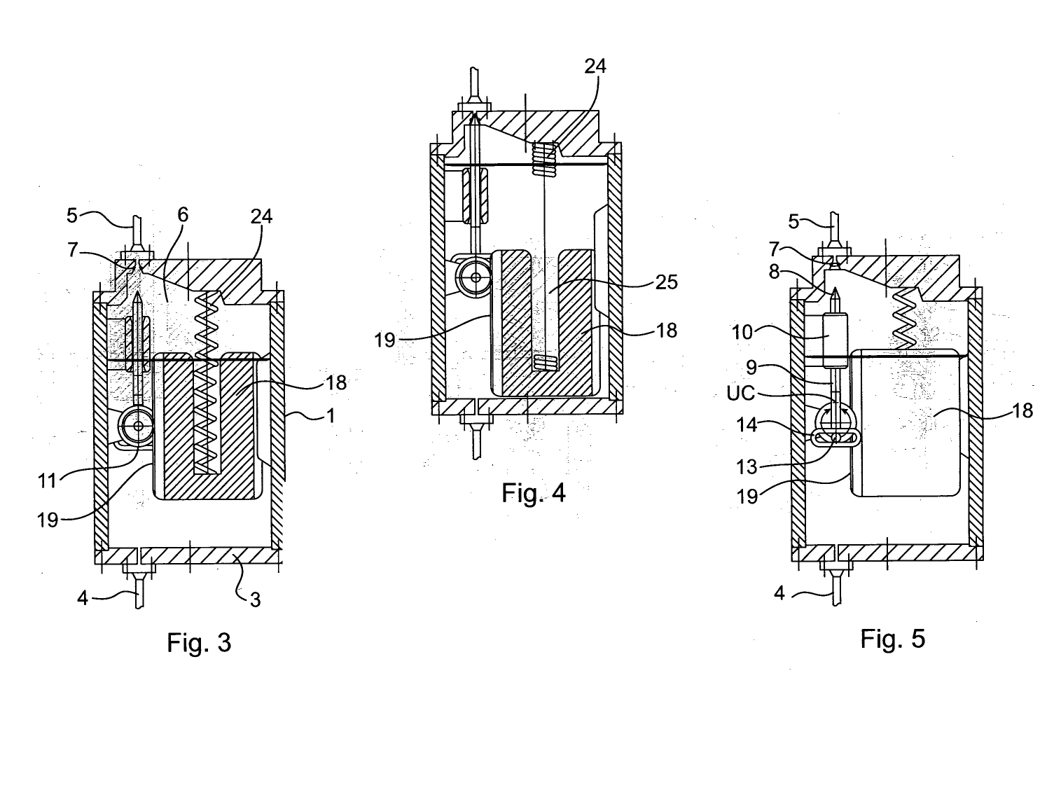

The valve housing 1 is connected to a liquid flow at an uppermost point of a liquid circuit, causing trace amounts of gas that is entrapped in the liquid to accumulate in the top region of the valve housing. As long as only a moderate volume of the valve housing is occupied by gas, the liquid lifts the floater to its top position wherein the valve closes the outlet 5, as illustrated in FIG. 1. As the gas volume successively increases in the top of the valve housing, a liquid volume that occupies the lower region of the valve housing is correspondingly pressed out of the valve housing. The floater follows the lowering liquid level towards the floor of the valve housing, thus opening the valve to let out the gas from the top region of the valve housing as illustrated in FIG. 3.

The vertical length of the gear rack 19 and the radius of the gear wheel 11 are chosen such that the gear wheel 11 is rotated nearly a full circle during maximum vertical travel of the floater, from its uppermost to its lowermost position in the valve housing. For example, the gear rack and gear wheel may be engaged with a ratio that, in normal operation, defines the maximum length of travel of the valve body in the closed-to-open direction as less than 50% of the maximum downward travel of the floater as illustrated in FIG. 5. More precisely, the cam fingers 13 shall not be allowed to pass the upper vertical center UC of the gear wheel in the closed position of the valve. In effect of this geometry and a non-slip engagement between the gear rack and the gear wheel, the floater movement will be stopped by the valve body resting in the valve seat in the closed state of the valve, in both end positions of the floater. A fail-close operation is in this way provided as the valve will remain in closed position should the floater loose buoyancy and sink towards the floor of the valve housing. FIG. 4 illustrates the valve arrangement in the fail-close mode, wherein the floater is arrested just above the floor of the valve housing in result of the valve body being received in the valve seat, in the closed state of the valve.

In the embodiment illustrated in FIGS. 1 to 5 the floater 18 is a solid metal body. The floater may alternatively be a hollow pressure vessel having metal walls which are dimensioned to withstand the pressures prevailing at subsea applications, down to water depths of one kilometer or more, e.g. In both alternatives, the structural requirements for the floater will increase the mass to a point where the mass is greater than the resulting buoyancy. According to an embodiment of the invention, an external force is applied to the floater, to compensate for the structural mass in order to neutralize the floater system with respect to the specific density of the fluid and the system pressure.

A force means 24 is to this purpose arranged in order to increase the buoyancy of floater. In the illustrated embodiment the force means is realized as a tension spring 24 that supports the floater 18 from the ceiling of the valve housing. The spring 24 is anchored in the bottom of a seat 25 that is formed as a blind bore which opens in the center at the upper end of the floater.

A purely mechanical device is in this way provided and configured to automatically collect, detect and release gas that is entrained in liquid that circulates in a subsea fluid circuit, such as a barrier fluid circuit for a subsea pump or compressor.

From the above, a skilled person will realize that modifications of the illustrated embodiment are possible without departing from the teaching of this invention which is reflected in the appended claims.

What is claimed is:

1. A gas venting valve arrangement comprising:
a valve housing comprising an inlet in a bottom region of the housing connectable to a liquid circuit in a subsea production system, and an outlet for gas accumulating in a top region of the valve housing;
a valve mechanism in the housing, the valve mechanism operating a movable valve body at the outlet between an open position and a closed position; and
a floater in the valve housing actuating the valve mechanism, wherein the floater is acted upon by a load dimensioned to increase buoyancy of the floater with respect to a liquid phase of the fluid accumulating in a bottom region of the valve housing.

2. The valve arrangement of claim 1, wherein the load is a tension spring supporting the floater from a ceiling of the valve housing.

3. The valve arrangement of claim 1, wherein the load is a compression spring supporting the floater from a floor of the valve housing.

4. The valve arrangement of claim 1, wherein the floater is mechanically linked to the valve body and the movement of the valve body is proportional to the movement of the floater.

5. The valve arrangement of claim 4, wherein a gear wheel in the valve mechanism engages a gear rack on the floater.

6. The valve arrangement of claim 5, wherein the valve housing further comprises at least one first guide configured to control the floater in a linear movement, and at least one second guide configured to control the valve body in a linear movement.

7. The valve arrangement of claim 5, wherein a cam and cam follower arrangement in the valve mechanism converts rotation of the gear wheel to a linear movement of the valve body.

8. The valve arrangement of claim 7, wherein the cam and cam follower arrangement comprises a finger moving in a circular path with the gear wheel, the finger engaging a guide slot formed in a lower end of a valve rod, an upper end of which carries the valve body.

9. The valve arrangement of claim 8, wherein the length of the gear rack on the floater and the radius of the gear wheel in the valve mechanism are correlated to generate almost a full circle of rotation of the gear wheel during maximum travel of the floater.

10. The valve arrangement of claim 9, wherein the gear wheel and gear rack are engaged with a ratio that defines the maximum length of travel of the valve body in the closed-to-open direction as less than 50% of the maximum travel of the floater.

11. The valve arrangement of claim 1, wherein the valve mechanism comprises:
a valve rod journalled to slide in a guide supported on an inside wall of the valve housing;
an upper end of the valve rod above the guide carrying the valve body;
a lower end of the valve rod below the guide shaped as a fork having two legs, each of which carries a guide slot oriented transversely to the longitudinal direction of the valve rod; and
a couple of disks arranged inwardly of said legs,
wherein each of the disks carries a finger projecting into one of said guide slots, respectively, and
wherein the disks are interconnected by an axle that is non-rotationally passing through the center of a gear wheel, and the axle is journalled for rotation in a bracket projecting from the inside wall of the valve housing.

12. The valve arrangement of claim 1, wherein the floater comprises:
a body connectable to a tension spring;
a groove running in longitudinal direction formed on the exterior of the body;
a gear rack supported on the exterior of the body, running in longitudinal direction opposite to the groove.

13. The valve arrangement of claim 1, wherein the valve housing further comprises:
a mounting bracket for the valve mechanism projecting inwardly from an inside wall of the housing;
a first guide vane projecting inwardly from the inside wall of the housing, running in longitudinal direction opposite to the mounting bracket; and
a couple of second guide vanes projecting inwardly from the inside wall of the housing, running in longitudinal direction and equally angularly spaced from the first guide vane.

14. The valve arrangement of claim 1, wherein the inlet to the valve housing is connected to a barrier fluid circuit for a subsea pump or a compressor.

15. The valve arrangement of claim 2, wherein the floater is mechanically linked to the valve body and the movement of the valve body is proportional to the movement of the floater.

16. The valve arrangement of claim 15, wherein a gear wheel in the valve mechanism engages a gear rack on the floater.

17. The valve arrangement of claim 16, wherein the valve housing further comprises at least one first guide configured to control the floater in a linear movement, and at least one second guide configured to control the valve body in a linear movement.

18. The valve arrangement of claim 3, wherein the floater is mechanically linked to the valve body and the movement of the valve body is proportional to the movement of the floater.

19. The valve arrangement of claim 6, wherein a cam and cam follower arrangement in the valve mechanism converts rotation of the gear wheel to a linear movement of the valve body.

20. The valve arrangement of claim 19, wherein the cam and cam follower arrangement comprises a finger moving in a circular path with the gear wheel, the finger engaging a guide slot formed in a lower end of a valve rod, an upper end of which carries the valve body.
